(19) United States
(12) Patent Application Publication
(10) Pub. No.: US 2010/0007768 A1
(43) Pub. Date: Jan. 14, 2010

(54) WIRELESS STORAGE DEVICE

(76) Inventors: Khai Leong Yong, Singapore (SG); Cheng Ann Tan, Singapore (SG); Bing Han, Singapore (SG)

Correspondence Address: BRIAN M. MCINNIS, 12th Floor, Ruttonjee House, 11 Duddell Street, Hong Kong, HK

(21) Appl. No.: 12/441,142

(22) PCT Filed: Sep. 15, 2006
(86) PCT No.: PCT/SG06/00268

§ 371 Date: Mar. 13, 2009

(51) Int. Cl. H04N 5/76

(52) U.S. Cl. 348/231.9; 348/E05.061

(57) ABSTRACT

There is provided a storage device including: a wireless communication link to communicate between the storage device and a digital imaging device; a storage medium for storing a digital image from the digital imaging device; where the digital image is wirelessly transferred between digital imaging device and the storage medium in real-time. The storage device enables the real-time storage of a digital image captured from a digital imaging device using a wireless interface. The storage device provides standalone operation without the need for a personal computer. The digital images stored in the storage device can be transmitted to peripheral components either by a wire connection or wireless transmission to such peripheral devices as a printer or directly to a web site for image loading and sharing. There is also provided a method of storing a digital image in a storage device.

### FIELD OF THE INVENTION

The present invention is related to a wireless storage device, and in particular a wireless storage device which enables real-time storage of a digital image during image capture.

### BACKGROUND OF THE INVENTION

The use of digital cameras is becoming increasingly widespread. Captured digital images are typically stored in image files within the camera on some type of storage media, such as an internal flash memory, a removable hard drive, or on a removable flash memory card. While digital cameras do alleviate the hassles of using and developing film that are required by film-based cameras, digital cameras are not without their share of concerns. One main concern is the maintenance of storage space in the digital camera. Most users desire the ability to take images on an instant's notice. Inherently, a limitation exists due to the cameras storage capacity. Even with the use JPEG compression techniques to efficiently utilize storage, users are often hampered when taking an image as a result of a lack of storage space. Thus, the ability to efficiently increase the storage capacity for a digital camera is highly desirable.

Further, the level of storage requirements for digital cameras will continue to increase as the resolution and numbers of megapixels also increase. The amount of storage required is further exacerbated by professional photographers using high resolution cameras that take a large number of pictures in the course of their work. To address these storage requirements, digital cameras rely on the use of external memory card devices (SD, MMC, CompactFlash, etc) for additional storage. The number of storage devices which can be installed within an electronic still camera, however, is restricted by the size of the housing of the camera. Accordingly, in order to record or keep a larger number of images, external storage devices which are to be connected to the electronic still camera by way of a cable have been developed.

Another option which exists is to have a large number of external memory card devices available to replace the internal memory card when its capacity has been reached. This is not only awkward but also increases the chance that the user may miss capturing the desired image or scene taking place due to the process of having to swap memory cards. The large number of memory cards also adds the problem of having to manage multiple memory cards. With a large number of external memory cards, a user faces the inconvenience of locating the desired images in the respective memory cards.

These external storage devices such as a large capacity hard disk drive suffer from the limitation of high power consumption and will therefore only provide the user with a limited amount of time in which to store images before requiring either a recharge or replacement of batteries.

As stated above external storage devices have been developed which are connected to a digital camera by way of a cable. Typically the wired interface is a USB or FIREWIRE connection for transferring images to a computer or other storage medium. The problem which exists is that a cable connection is required; this introduces the hassle of plugging and unplugging the connection and does not allow for ease of use due to the restriction introduced by the cable.

Further existing external storage devices which are connected by way of a cable or via wireless connection to the digital camera are used to store images already captured by the digital camera. The digital camera is connected to a USB device via a USB cable for data transfer once the digital camera has captured the image and stored it on an internal memory card. The digital camera connected to a USB storage device does not have the ability to store an image in real-time. Further the camera cannot operate in capture mode at the same time as transferring an image already captured to the external storage device.

Given the aforementioned trend toward memory cards, and despite some proposals for image-specific capabilities in digital storage devices, it has been the responsibility of the digital camera to configure and manipulate the image data into a form suitable for storage. Because an image is described by a large amount of binary data, sometimes megabytes of data, it is a particular responsibility of the camera to compress and otherwise transform the data for storage. For instance, this may involve manipulation of colour-spaces and image detail. As a result, the data in the digital storage device is only intelligible to a camera (or processor) of the type that originally configured and manipulated the data. The digital camera will normally store an image and carry out any manipulation of the image prior to the image being transferred to a external storage device. There is no real time transfer of the image prior to the image being saved to an internal storage device.

It is an object of the present invention to provide an alternative and improved wireless storage device wherein the device can be used to store an image in real time.

Any discussion of documents, acts or knowledge in this specification is included to explain the context of the invention. It should not be taken as an admission that any of the material forms part of the prior art base or the common general knowledge in the relevant art.

### SUMMARY OF THE INVENTION

With the above object in mind the present invention provides a storage device including:

a wireless communication link to communicate between said storage device and a digital imaging device;

a storage medium for storing a digital image from said digital imaging device;

wherein said digital image is wirelessly transferred between said digital imaging device and said storage medium in real-time.

The present invention provides a storage device that enables the real-time storage of a digital image captured from a digital imaging device using a wireless interface. The storage device provides standalone operation without the need for a personal computer. The digital images stored in the storage device can be transmitted to peripheral components either by a wire connection or wireless transmission to such peripheral devices as a printer or directly to a web site for image loading and sharing.

In a further arrangement, the present invention provides a method of storing a digital image in a storage device, including the steps of:

a) transmitting a digital image from a digital imaging device to said storage device via a wireless communication link;

b) storing said digital image in a storage medium in said storage device;

c) processing the digital image stored in said storage medium by a controller;

d) transferring said digital image from said storage device to a peripheral component;

wherein said digital image is wirelessly transferred between said digital imaging device and said storage device in real-time.

In still a further arrangement the present invention provides a storage device including:

a wireless communication link to communicate between said storage device and a digital imaging device;

a storage medium for storing a digital image from said digital imaging device;

a battery for portable operation of said storage device;

a controller for processing the digital image stored in said storage medium, said controller transfers said digital image from said storage device to a peripheral component;

a LCD display screen to view the digital images stored in said storage medium;

wherein said digital image is wirelessly transferred between said digital imaging device and said storage device in real-time.

Preferably the storage device further includes a controller for image enhancement to process said digital image.

The storage device also eliminates the need to transfer images to a personal computer for image enhancement as the device can incorporate such image processing capability such as red-eye reduction, brightness enhancement etc.

Preferably said wireless communication link further includes a detection and a handshake mechanism for pairing the digital imaging device to said storage device for seamless operation.

Preferably said controller further includes a MPU/CPU and a memory device.

Preferably said storage device further includes a battery for portable operation of said storage device, wherein said storage device uses said memory device for buffering and caching said digital image to provide power management to conserve said battery life.

Preferably said storage device further includes a LCD display screen to view the digital images stored in said storage medium.

Preferably the transfer of said digital image from said storage device to a peripheral component is via a wireless communication link or a wired connection such as a USB cable or a Firewire.

Preferably said storage medium includes a hard disk drive, a optical disk or a flash drive for storing said image.

Preferably during the transfer of said digital image from said storage device to a peripheral component, said storage device can be accessed by the peripheral component via both a wireless communication link and a wired communication link simultaneously.

Preferably said wireless communication link further includes a auto-detect mode to automatically detect a surrounding available wireless network and automatically join to a preferred network that can be configured, a multiple of preferred networks can be configured and a priority can be set for each preferred network. Wherein said storage device can operate as a master in the preferred network, controlling the transfer of said digital image in the network among the peripheral components.

Preferably said LCD display panel further includes at least one button used as a user interface for command and common file operations of the digital image stored.

Preferably said LCD display further includes a touch-screen as the user interface.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 is a block diagram of the device according to one embodiment of the present invention.

FIG. 2 shows the device of FIG. 1 transferring data via a wireless interface to external peripheral components according to one embodiment of the present invention.

FIG. 3 shows the device of FIG. 1 transferring data via a wired interface to external peripheral components according to one embodiment of the present invention.

FIG. 4 shows the device of FIG. 1 and data transfer between the device and peripheral components via a wireless communication link according to one embodiment of the present invention.

FIG. 5 shows the device of FIG. 1 and data transfer between the devices and peripheral components via a wired connection according to one embodiment of the present invention.

### DESCRIPTION OF PREFERRED EMBODIMENT

The present invention will be discussed hereinafter in detail in terms of the preferred embodiment of a wireless storage device according to the present invention with reference to the accompanying drawings. In the following description, numerous specific details are set forth in order to provide a thorough understanding of the present invention. It will be obvious, however, to those skilled in the art that the present invention may be practiced without these specific details.

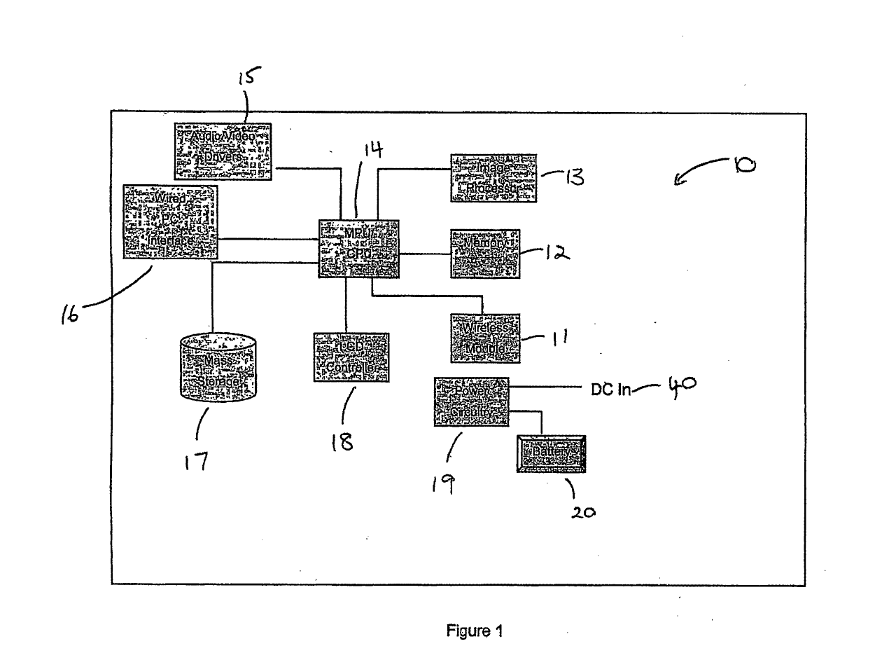

FIG. 1 shows a block diagram of the wireless storage device 10 according to one embodiment of the present invention. The storage device 10 is a portable digital storage device which uses a wireless communication link 21 to interact with a digital imaging device 30 and peripheral components 31, 32, 33, 34, 35. The storage device 10 can be used as a storage server or image enhancing device. As a storage server it can transfer the digital image contents and commands to a peripheral component such as for example a display 33, a printer 34 or computer 35.

The storage device 10 is designed for mobility and is a standalone device which can be operated without the need of any peripheral devices in order to operate as a storage device 10 or a storage server. The storage device 10 includes a Micro-Processing Unity Computer Processor Unit (MPU/CPU) 14 which further includes an operating system and embedded software to control and communicate with an internal storage medium 17 such as a hard disk drive (HDD) such as 1.8″ or 1″ HDD, or semiconductor memories such as Flash, RAM, optical storage, or CRAM. The storage device 10 also includes both a wired connection interface 16 and a wireless connection interface module 11 for controlling data transfers to external peripheral components 31, 32, 33, 34, 35 and digital imaging device 30 such as a digital camera. Further to protect the HOD a dampener (not shown) is incorporated to encapsulate the HDD. The dampener provides absorption and distribution of the forces around the HDD by reducing the impact of force on the HDD if or when the HDD is dropped or a sudden jerk of movement occurs. The dampener material consists of material that will absorb and distribute force.

The storage device 10 is powered by a battery 20 in conjunction with power circuitry 19 which allows the storage device 10 to operate as a portable standalone device. Optionally the storage device 10 may be powered via a DC input 40 by an AC/DC transformer (not shown). The power circuitry 19 is used to control the power requirements for the storage device 10. The power circuitry 19 also maintains and conserves the life of the battery 20 by using the memory device 12 for buffering and caching said digital image. The storage device 10 also uses the memory device 12 as a buffer (volatile or non-volatile) to temporarily store the digital image contents received prior to committing the contents to its more permanent storage medium 17 such as hard disk drive, optical disk or flash drive.

The memory device 12 also stores the firmware instructions for the storage device 10. Some of the instructions are as follows:
Intelligent protocol detection and handshake mechanism;
implementation of picture transfer protocol (PTP-IP) for data transfer (digital image) between the storage device 10 and digital imaging device 30;
Algorithm to manage buffering of the digital image content and for power conservation of the HDD 17;
Algorithm for reliable content transfer between digital imaging device 30 and the storage device 10 to ensure minimal image loss during the transfer operation;
Algorithm for intelligent indexing of the content/images;
Algorithm for image self-enhancement;
Intelligent WLAN network setup and detection for seamless operation in various network (Ad-hoc, Infrastructure and Access Point);
Encryption support such as wireless encryption protocol (network security) (WEP) and Wi-Fi protected access 2 (WPA2) encryption support for security over WLAN network;
Embedded web server for configuration and content management;
Multi-tasking real-time implementation for efficient and performance.

The storage device 10 can also be used as a image enhancing device such that a user can carry out such functions as red-eye reduction, brightness enhancement etc without the need to transfer the digital image to a computer 35 or other peripheral device for digital enhancement to the digital image captured by the digital camera 30. To allow the storage device 10 to manipulate the digital image the device 10 includes both an image processor 13 and audio/video drivers 15. These devices are controlled by the MPU/CPU 14 to allow the user to perform such enhancement functions as mentioned above.

To allow the user to view the digital image and also for enhancement of the digital image the storage device 10 includes a LCD panel and controller 18. Preferably the LCD panel and controller 18 includes a panel of buttons (not shown) used as a user interface for command and common file operations of the stored digital image. Some of these operations include for example, viewing, renaming, selecting, deleting, and enhancement/etc. As a further option the LCD panel and controller 18 can further includes a touch-screen as the user interface.

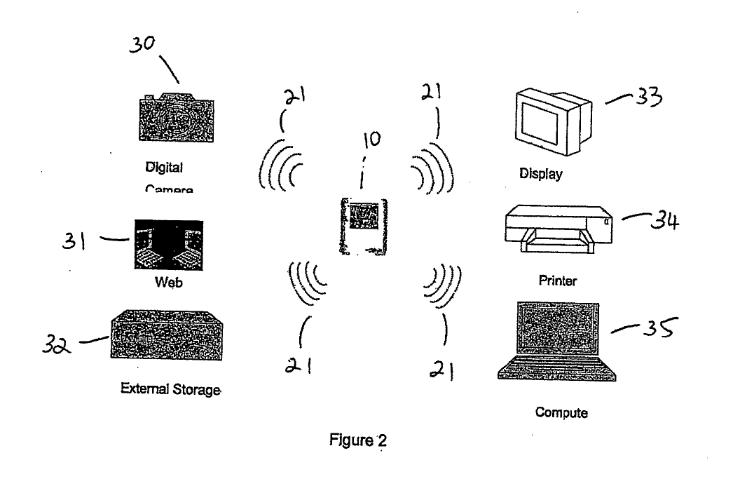

As shown in FIG. 2 the wireless connection interface module 11 provides the wireless interface for the communication link that is used for data transfer (digital images) and to command the external peripheral components 31, 32, 33, 34, 35 and digital imaging device 30 such as a digital camera There are two possible options for the transfer of images from the digital imaging device 30. Firstly, when the digital imaging device 30 is in photographic image capture mode for instantaneous transfer of image to the storage device 10 or secondly in an offline mode where the digital imaging device 30 provides basic functions such as to view, move and transfer images. The transfer sequence can be summarized as:
1. Either the camera 30 or storage device 10 will detect the availability of a network 21 and subsequently join that wireless network 21.
2. Both the camera 30 and the storage device 10 have the ability to Implement auto-discovery, to automatically discover the presence of each other.
3. An optional authentication mode may be included to verify the identity of each device.
4. One or more connections (UDP/TCP/IP) are established for communication.
5. All devices may communicate with each other to advertise to each other their capabilities and features.
6. Either the camera 30 or storage device 10 shall then initiate the image transfer.
7. The image is segmented into data frame packets and sent over the wireless network 21.
8. The camera 30 and/or the storage device 10 may implement a data recovery mechanism if substantial packet loss is experienced by the network 21.
9. Upon completion of image transfer acknowledgement is required.
10. The wireless connection will either remain open for further image transfer or will close on completion of the transfer.
   The transfer of data between the storage device 10 and the peripheral components 31, 32, 33, 34, 35 is carried out in a similar manner as described above. However, the storage device 10 also has the ability to establish communication and data transfer with more than one peripheral device 31, 32, 33, 34, 35 as follows:
1. Either the storage device 10 or the peripherals components 31, 32, 33, 34, 35 will detect the availability of a network 21 and subsequently join the wireless network 21.
2. Both the peripheral components 31, 32, 33, 34, 35 or the storage device 10 have the ability to implement auto-discovery to automatically discover the presence of each other.
3. An optional authentication mode may be included to verify the identity of each device.
4. One or more connections (UDP/TCP/IP/HTTP) are established for communication.
5. All devices may communicate with each other to advertise to each other their capabilities and features.
6. Either the storage device 10 or the peripheral components 31, 32, 33, 34, 35 shall then initiate the image transfer.
7. The image is segmented into data frame packets and sent over the wireless network 21.
8. The storage device 10 and/or the peripheral components 31, 32, 33, 34, 35 may implement a data recovery mechanism if substantial packet loss is experienced by the network 21.
9. Upon completion of image transfer acknowledgement is required.
10. The wireless connection will either remain open for further image transfer or close on completion of the transfer.

The wireless connection interface module 11 can include a wireless local area network (WLAN), ultra wideband network (UWB) or a Bluetooth wireless connection or similar network 21. The wireless connection interface module 11 allows image capture from the digital imaging device 30 to be performed in real-time and stored directly to the storage medium 17 in the storage device 10. This provides the user with mobility in using their digital imaging devices 30 without the need for a cable connection to transfer the digital image to the storage medium 17. The wireless connection interface module 11 also allows the storage device 10 to be able to wirelessly transfer the stored digital image to peripheral components 31, 32, 33, 34, 35.

The transfer of the digital image from the digital imaging device 30 is in real-time. When an image is captured by a digital imaging device 30 the digital image is stored to the storage device 10 while the digital imaging device 30 is still in capture mode. Alternatively the image can be saved to an internal/attached memory card of the digital imaging device 30 prior to being saved directly to the external wireless storage device 10. This is dependent on the implementation of the digital imaging device 30. Based on current wireless digital imaging device 30 models, the images will be stored (fully or partially) to the internal/attached memory card prior to transmitting to the storage device 10 via the wireless network 21.

The transport and network protocols used for transfer and communication on the wireless network 21 are based on the commonly used TCP/UDP/IP protocols. The intelligent wireless network 21 provides seamless operation of the wireless network 21 in various settings such as ad-hoc, access point or infrastructure.

In an infrastructure type of network there is a base station (wireless router or access point in WLAN network) that controls the network in terms of:
1. creating a wireless network for devices to join
2. performing and enforcing the security employed in the network (eg WEP or WPA or etc for WLAN network)
3. assigning IP addressing to any device that joins the network
4. routing packets to their desired destination

In an infrastructure type network, the storage device 10 will take a passive role and act as a wireless client device, joining to the infrastructure wireless network. The storage device 10 will communicate to the base station for all data and command transfers. The base station will then route the data commands to the peripheral components 31, 32, 33, 34, 35 and digital imaging device 30. The operation occurs in reverse when data is transferred from the peripheral components 31, 32, 33, 34, 35 and the digital imaging device 30 to the storage device 10.

In an ad-hoc mode type network there is no wireless base station and the storage device 10 will have the functionality of a dynamic host configuration protocol (DHCP) server assigning IP addresses to any of the peripheral components 31, 32, 33, 34, 35 and the digital imaging device 30 in order for each device in the network to be able to identify each other for data communications. The data is transferred directly on a one to one basis between a receiver and a sender in the wireless network 21.

In access point mode, the storage device 10 takes the role of a base station and all data communications from all peripheral components 31, 32, 33, 34, 35 and the digital imaging device 30 in the network will be directed to the storage device 10 prior to resending the data to the designated device. The storage device 10 will take over the roles of assigning IP addresses to all connected devices and re-route data to the final destination.

The wireless network 21 is designed such that the storage device 10 is able to automatically detect the surrounding available wireless network 21 and automatically join to the preferred network 21 that can be configured for the transfer of the digital image. The wireless network 21 also allows multiple preferred networks to be configured and priority can be set for each preferred network 21.

The automation in joining a preferred network is only applicable to an infrastructure type network. In an infrastructure type network, a base station/access point will create a wireless network 21 that is identified by a service set identifier (SSID) or network name (also differentiates one WLAN from another). Hence, if the storage device 10 is configured to operate in infrastructure mode, it needs to know which SSID or wireless network 21 to join. The storage device 10 is designed such that a list of preferred networks can be configured on the storage device 10 and when operating in an infrastructure mode, the storage device 10 will automatically scan and detect the surrounding network for any wireless networks 21 that match the list of preferred networks stored in its database. It will automatically join if there is a match, eliminating the need for the user to constantly manipulate the storage device 10 to find a network to join. In the event that there are multiple matching networks available, the storage device's database of preferred networks will have a precedence or priority indication to decide on the final network to join. The precedence or priority is configured on the storage device 10 through a graphical user interface (GUI) or interface found in the LCD/buttons.

Finally, the wireless storage device 10 can operate in a master/slave configuration in the predefined wireless network 21, controlling the transfer and communication in the wireless network 21 among the various peripheral components 31, 32, 33, 34, 35 joined to the wireless network 21. The storage device 10 operates as a client (instead of as a base station) in an infrastructure network where there is already an existence of a base station.

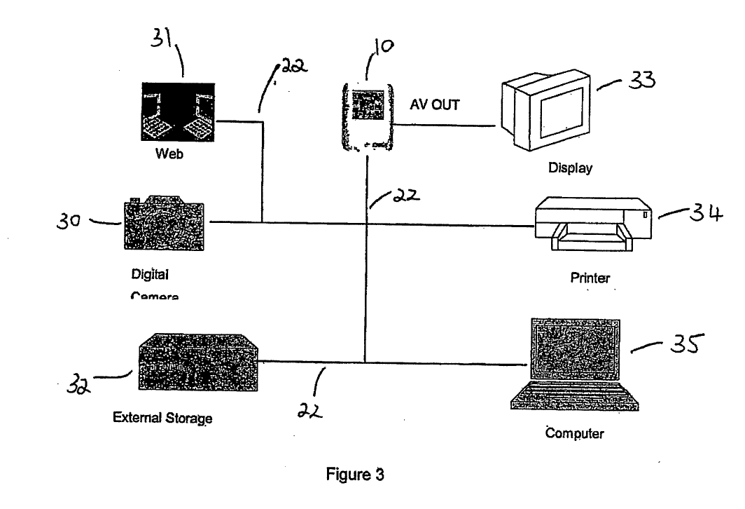

As a further option and as shown in FIG. 3, the storage device 10 also has a wired connection interface 16 which allows the transfer of the stored digital image via such mediums as a universal serial bus (USB), Firewire or similar wired connection 22. The storage device 10 allows the digital image to be connected to the peripheral components 31, 32, 33, 34, 35 by the wired connection interface 16.

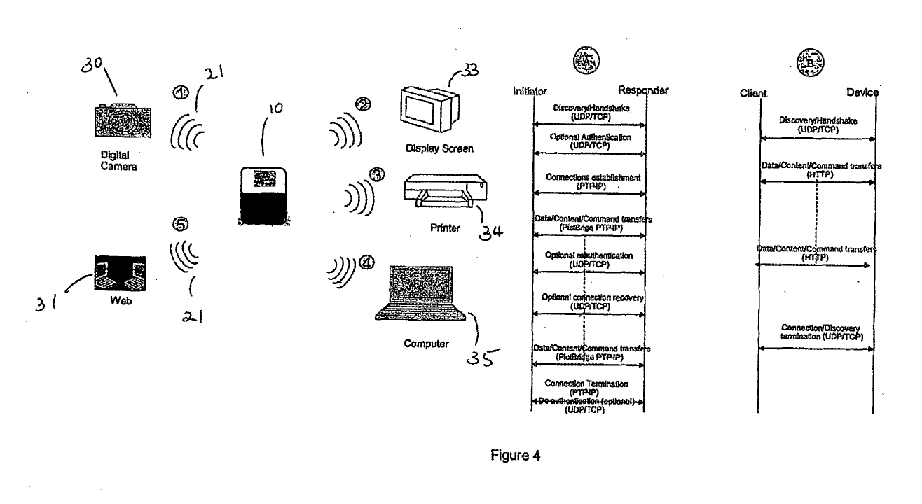

FIG. 4 shows the storage device 10 and data transfer between the storage device 10 and peripheral components 30, 31, 33, 34, 35 via a wireless network connection link 21. Connections or data transfers can be established simultaneously between the storage device 10 and other peripheral devices such as a digital camera 30 or computer 35, for example. The A mechanism of communication and data transfer is used between the storage device 10 and the digital camera 30, the display screen 33 and the printer 34. The internet or World Wide Web 31 uses mechanism B and the computer 35 can use either mechanism A or B.

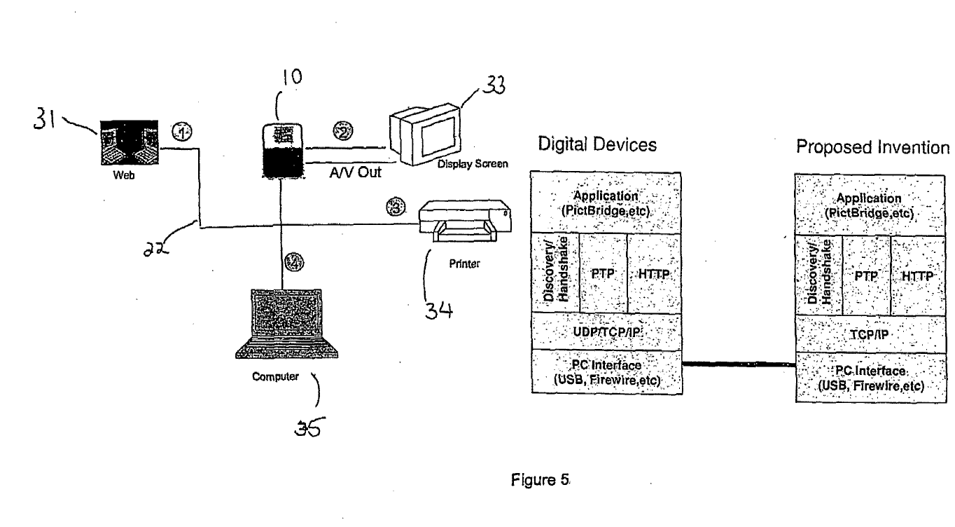

FIG. 5 shows the storage device 10 using data transfer between the storage device 10 and peripheral components 31, 33, 34, 35 via a wired connection 22. Connections or data transfers are established between the storage device 10 and other digital devices such as printer 34 or computer 35, for example using a standard PC interface such as USB or Firewire. Simultaneous connection will be dependent on the PC interface bus technology capability. FIG. 5 highlights the layers of communication between the storage device 10 and the peripheral components through the wired interface 22. In a further option, the storage device 10 may also employ an audio/visual output as an analog interface to directly supply analog signals to the display screen 33.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A storage device including:
a wireless communication link to communicate between said storage device and a digital imaging device;
a storage medium for storing a digital image from said digital imaging device;
wherein said digital image is wirelessly transferred between said digital imaging device and said storage medium in real-time.

2. The storage device of claim 1, further includes a controller for image enhancement to process said digital image.

3. The storage device of claim 2, wherein said controller further controls the transfer of said digital image from said storage device to a peripheral component.

4. The storage device of claim 1, wherein said wireless communication link further includes a detection and a handshake mechanism for pairing the digital imaging device to said storage device for seamless operation.

5. The storage device of claim 4, wherein said wireless communication link consists of any one of a WLAN, a UWB, or a Bluetooth link or similar wireless link.

6. The storage device of claim 2, wherein said controller further includes a MPU/CPU and a memory device.

7. The storage device of claim 6, further including a battery for portable operation of said storage device, wherein said storage device uses said memory device for buffering and caching said digital image to provide power management to conserve said battery life.

8. The storage device of claim 1, further includes a LCD display screen to view the digital images stored in said storage medium.

9. The storage device of claim 6, wherein said memory device stores the digital image received from said digital imaging device prior to saving said digital image to said storage medium.

10. The storage device of claim 6, wherein said memory device is chosen from a semiconductor memory device, a semiconductor magnetic memory device or a optical storage device.

11. The storage device of claim 3, wherein the transfer of said digital image from said storage device to a peripheral component is via a wireless communication link or a wired connection such as a USB cable or a Firewire.

12. The storage device of claim 11, wherein during the transfer of said digital image from said storage device to a peripheral component, said storage device can be accessed by the peripheral component via both a wireless communication link and a wired communication link simultaneously.

13. The storage device of claim 1, wherein said storage medium includes a hard disk drive, a optical disk or a flash drive.

14. The storage device of claim 1, wherein said wireless communication link further includes:
an auto-detect mode to automatically detect a surrounding available wireless network and automatically Join to a preferred network that can be configured;
a multiple of preferred networks can be configured and a priority can be set for each preferred network;
wherein said storage device can operate as a master in the preferred network, controlling the transfer of said digital image in the network among the peripheral components.

15. The storage device of claim 8, wherein said LCD display panel further includes at least one button used as a user interface for command and common file operations of the digital image stored.

16. The storage device of claim 15, wherein said LCD display further includes a touch-screen as the user interface.

17. A method of storing a digital image in a storage device, including the steps of:
a) transmitting a digital image from a digital imaging device to said storage device via a wireless communication link;
b) storing said digital image in a storage medium in said storage device;
c) processing the digital image stored in said storage medium by a controller;
d) transferring said digital image from said storage device to a peripheral component;
wherein said digital image is wirelessly transferred between said digital imaging device and said storage device in real-time.

18. A storage device including:
a wireless communication link to communicate between said storage device and a digital imaging device;
a storage medium for storing a digital image from said digital imaging device;
a battery for portable operation of said storage device;
a controller for processing the digital image stored in said storage medium, said controller transfers said digital image from said storage device to a peripheral component;
a LCD display screen to view the digital images stored in said storage medium;
wherein said digital image is wirelessly transferred between said digital imaging device and said storage device in real-time.
